(19) United States
(12) Patent Application Publication
(10) Pub. No.: US 2015/0183888 A1
(43) Pub. Date: Jul. 2, 2015

(54) COMPOSITION COMPRISING METAL SILICATES WITH REDUCED PARTICLES SIZES

(71) Applicant: Preservation Technologies I/S, Tarm (DK)

(72) Inventors: Michael Østerby, Vejle (DK); Mette Bjerregaard Blomgreen, Spjald (DK)

(21) Appl. No.: 14/418,637

(22) PCT Filed: Aug. 2, 2013
(86) PCT No.: PCT/DK2013/050258

§ 371 Date: Jan. 30, 2015

(30) Foreign Application Priority Data
Aug. 2, 2012 (DK) PCTDK2012050285
Aug. 2, 2012 (DK) PCTDK2012050286
Jan. 29, 2013 (DK) PA 2013 70050

(51) Int. Cl. C08B 15/00; B02C 17/20; C09K 15/02

(52) U.S. Cl. CPC C08B 15/00; C09K 15/02; B02C 17/20

(57) ABSTRACT

The present invention relates to compositions comprising metal silicates wherein the metal silicates have a reduced particle size distribution. The invention furthermore relates to processes for producing such compositions and uses of such compositions, e.g. for preserving cellulosic material.

The present invention relates to a modified liquid composition comprising metal silicates, such as sodium silicate, wherein the metal silicates have a reduced particle size relative to corresponding types of liquid metal silicates.

### BACKGROUND OF THE INVENTION

Metal silicates are a group of compounds including sodium silicate, potassium silicate and lithium silicate. Sodium silicate is the most widely used metal silicate, and is the common name for sodium metasilicate, Na₂SiO₃, also known as water glass or liquid glass. It is available in aqueous solution and in solid form and may find use in e.g. cements, passive fire protection, refractories, textile and lumber processing, and automobiles.

It has been known for several years that metal silicate and in particular sodium silicate can be used as e.g. a fire protective agent in wood preservation, such as in a paint composition or as an “impregnation” agent. However, the uptake of the metal silicate in the cellulosic material is limited, if any uptake happens at all.

WO 94/12289 discloses a method for using silicate compounds to create a surface protection of e.g. a wood article. The chemical properties of the silicate compounds are not further defined.

U.S. Pat. No. 6,146,766 discloses a method for fire-protecting cellulosic material with sodium silicate. It is described that the method uses a combination of vacuum and pressure to penetrate cellular walls. Increased fire protection appears to be documented, however there are no data showing that the sodium silicate actually penetrates the materials. Furthermore, the chemical properties of the used sodium silicate are not further defined.

WO 2009/008797 discloses a method for strengthening wood structures comprising the use of a waterglass composition having a pH below 5. This document does not define any further details on the chemical properties of the composition used, besides the pH.

In sum, none of the cited prior art addresses any problems with the chemical properties of sodium silicate in relation to the efficiency of penetrating the materials to which they are applied. Hence, there is a need for an improved metal silicate composition with improved properties which is stable, easy to produce and inexpensive.

### SUMMARY OF THE INVENTION

Though the prior art described above relates to preservation of cellulosic material with sodium silicate, none of WO 94/12289, U.S. Pat. No. 6,146,766 and WO 2009/008797 show any actual results demonstrating that the metal silicate is penetrating into cellulosic structures such as wood structures. Penetration efficiency may be influenced by the chemical structures of the metal silicate in the composition, in here represented by the particle sizes of the metal silicates. It is generally believed that the main factors influencing the chemical features of metal silicates are the mole ratio between the silicate and metal, the solid content of the metal silicate and the temperature. The present invention relates to a novel liquid metal silicate composition, such as sodium silicate, potassium silicate and/or lithium silicate, having a reduced particle size distribution relative to a corresponding type of liquid metal silicate, which has not been modified.

Generally the various structures of metal silicates depend on the SiO₂:Metal₂O ratio and each structure provide certain properties to the metal silicate. The present invention discloses a novel process for subjecting the liquid metal silicate composition to a modification treatment obtaining a new liquid metal silicate composition with new properties.

Thus, an object of the present invention relates to providing a modified metal silicate composition.

In particular, it is an object of the present invention to provide a modified metal silicate composition that solves the above mentioned problems of the prior art with penetration of metal silicate into wood structures.

Thus, one aspect of the invention relates a process for reducing the average particle size of metal silicates in a liquid composition, said process comprising
a) providing a first liquid composition comprising metal silicates,
b) subjecting said first liquid composition to mechanical modification treatment, obtaining a second composition, wherein the average particle size of the metal silicates in the second composition is reduced relative to the metal silicates in the first composition, and
c) optionally, subjecting said second composition to one or more steps of mechanical modification treatment.

As similar aspect relates to a process for reducing the average particle size of metal silicates in a liquid composition comprising
a) providing a first liquid composition comprising metal silicates,
b) subjecting said first liquid composition to mechanical modification treatment, obtaining a second composition, wherein the average particle size of the metal silicates in the second composition is reduced relative to the metal silicates in the first composition, and
c) optionally, subjecting said second composition to one or more steps of said mechanical modification treatment;
   wherein the mechanical modification treatment is performed by beading, milling, comminuting, grinding, sheer, compression/pressure, acceleration, impact, turbulence ball/bead milling, rotary impact milling and/or micronization; preferably bead milling using a bead mill.

Another aspect of the present invention relates to a liquid composition comprising metal silicate obtainable by a process according to the invention.

Yet another aspect of the present invention is to provide a liquid composition comprising metal silicates, wherein the average particle diameter of the liquid metal silicates are less than 100 μm, such as less than 50 μm, such as less than 10 μm, such as less than 5 μm, such as less than 3 μm, such as less than 1 μm, such as less than 0.1 μm, such as in the range 0.01-100 μm, such as in the range 0.01-100 μm, such as in the range 0.01-10 μm, such as in the range 0.01-1 μm or such as in the range 0.1-100 μm. Preferably at least 90% of the particles are at least 0.01 μm or at least 0.1 μm.

The compositions according to the present invention may find use in different applications. Thus, still another aspect of the present invention relates to the use of a composition according to the invention for preserving cellulosic material.

In particular, it is an object of the present invention to provide a liquid metal silicate composition and/or a process for preserving cellulosic material that solves the above mentioned problems of the prior art with respect to uptake of liquid metal silicate into cellulosic material e.g. a wood structure.

The present invention also discloses a process for providing a cellulosic material comprising a liquid metal silicate composition.

Thus, in an aspect the present invention relates to a process for providing a cellulosic material comprising a liquid metal silicate composition, the process comprises the steps of:
providing a liquid metal silicate composition according to the invention,
optionally diluting or concentrating said sodium silicate composition,
positioning said liquid metal silicate composition into and/or onto said cellulosic material.

Yet an aspect of the present invention relates to a process for providing a cellulosic material comprising metal silicate, the process comprising the steps of:
providing a liquid metal silicate composition according to the invention,
optionally diluting or concentrating said liquid metal silicate composition,
positioning said liquid metal silicate composition into and/or onto said cellulosic material, providing a cellulosic material comprising metal silicate.

Still another aspect relates to a cellulosic material obtainable by a process according to the invention.

The present invention will now be described in more detail in the following.

### BRIEF DESCRIPTION OF THE FIGURES

FIG. 1 shows the particle size distribution in the interval from 0.02-2000 μm of a first batch of unmodified sodium silicate type 44. A) After sonication. B) Before sonication.

FIG. 2 shows the particle size distribution in the interval from 0.02-2000 μm of sodium silicate type 44 modified by two hours of re-circularization in a bead mill. A) After sonication. B) Before sonication.

FIG. 3 shows the particle size distribution in the interval from 0.02-2000 μm of a second batch of unmodified sodium silicate type 44.

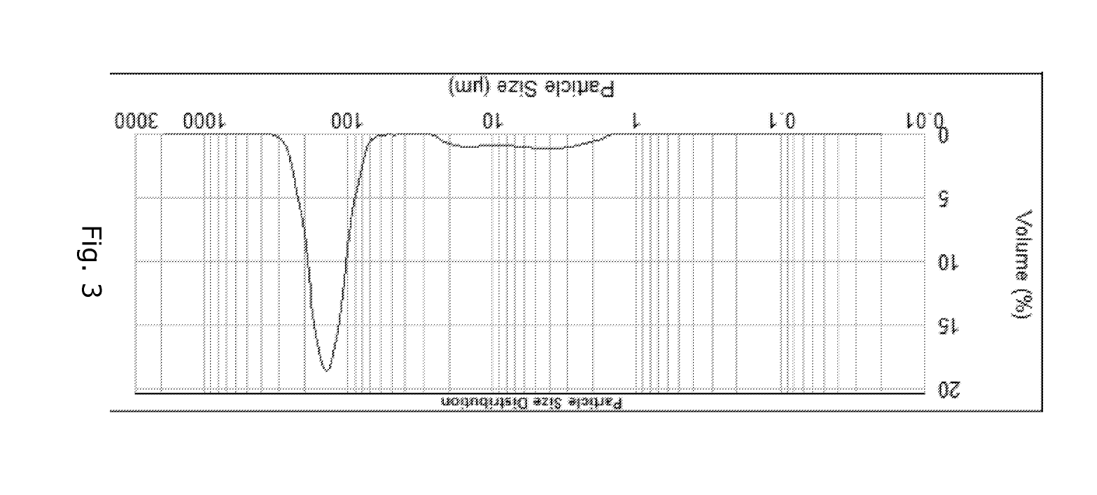

FIG. 4 shows the particle size distribution in the interval from 0.02-2000 μm of the second batch of sodium silicate type 44 modified by 1 run-through in a bead mill.

FIG. 5 shows the particle size distribution in the interval from 0.02-2000 μm of the second batch of sodium silicate type 44 modified by 3 run-throughs in a bead mill.

FIG. 6 shows the particle size distribution in the interval from 0.02-2000 μm of the second batch of sodium silicate type 44 modified by two hours of re-circularization in a bead mill.

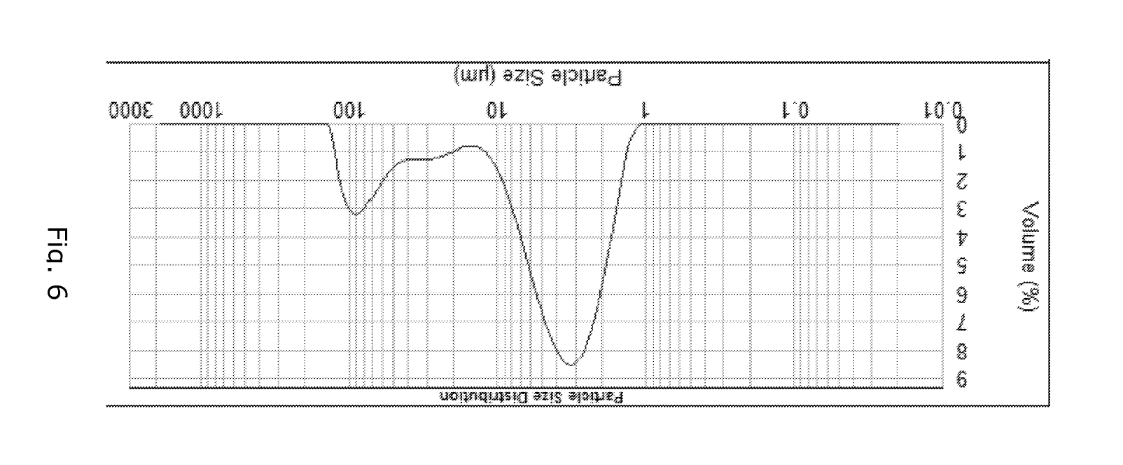

FIG. 7 shows the particle size distribution in the interval from 0.02-2000 μm of third batch of unmodified sodium silicate type 44. A) Number based distribution. B) Volume based distribution.

FIG. 8 shows the particle size distribution in the interval from 0.02-2000 μm of the third batch of sodium silicate type 44 modified 20 minutes in a bead mill with 0.4 mm zirconia beads. A) Number based distribution. B) Volume based distribution.

FIG. 9 shows the particle size distribution in the interval from 0.02-2000 μm of the third batch of sodium silicate type 44 modified 20 minutes in a bead mill with 0.8 mm zirconia beads. A) Number based distribution. B) Volume based distribution.

FIG. 10 shows the particle size distribution in the interval from 0.02-2000 μm of the third batch of sodium silicate type 44 modified 20 minutes in a bead mill with 1.3 mm zirconia beads. A) Number based distribution. B) Volume based distribution.

FIG. 11 shows the particle size distribution in the interval from 0.02-2000 μm of the third batch of sodium silicate type 44 modified 20 minutes in a bead mill with 1.55-1.85 mm glass beads. A) Number based distribution. B) Volume based distribution.

FIG. 12 shows the particle size distribution in the interval from 0.02-2000 μm of the third batch of sodium silicate type 44 modified 20 minutes in a bead mill with 2.2 mm zirconia beads. A) Number based distribution. B) Volume based distribution.

The present invention will now be described in more detail in the following.

### DETAILED DESCRIPTION OF THE INVENTION

### Process for Reducing the Average Particle Size of Metal Silicates

The present invention relates to a process wherein the average diameter of metal silicates is reduced by mechanical treatment. Thus, an aspect relates to a process for reducing the average particle size of metal silicates in a liquid composition comprising
a) providing a first liquid composition comprising metal silicates,
b) subjecting said first liquid composition to mechanical modification treatment, obtaining a second composition, wherein the average particle size of the metal silicates in the second composition is reduced relative to the metal silicates in the first composition, and
c) optionally, subjecting said second composition to one or more steps of mechanical modification treatment.

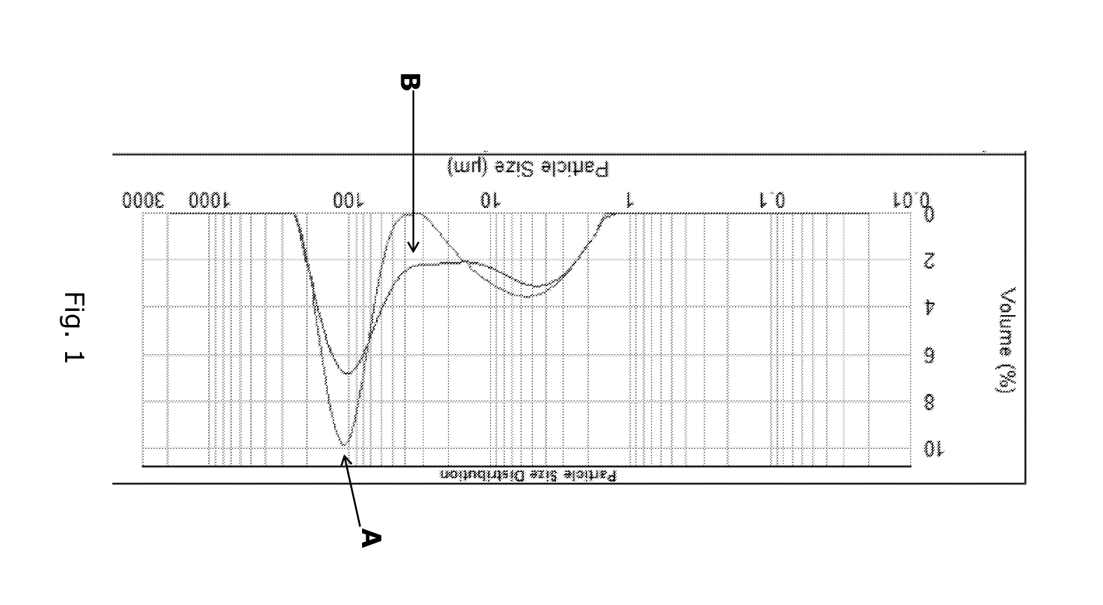

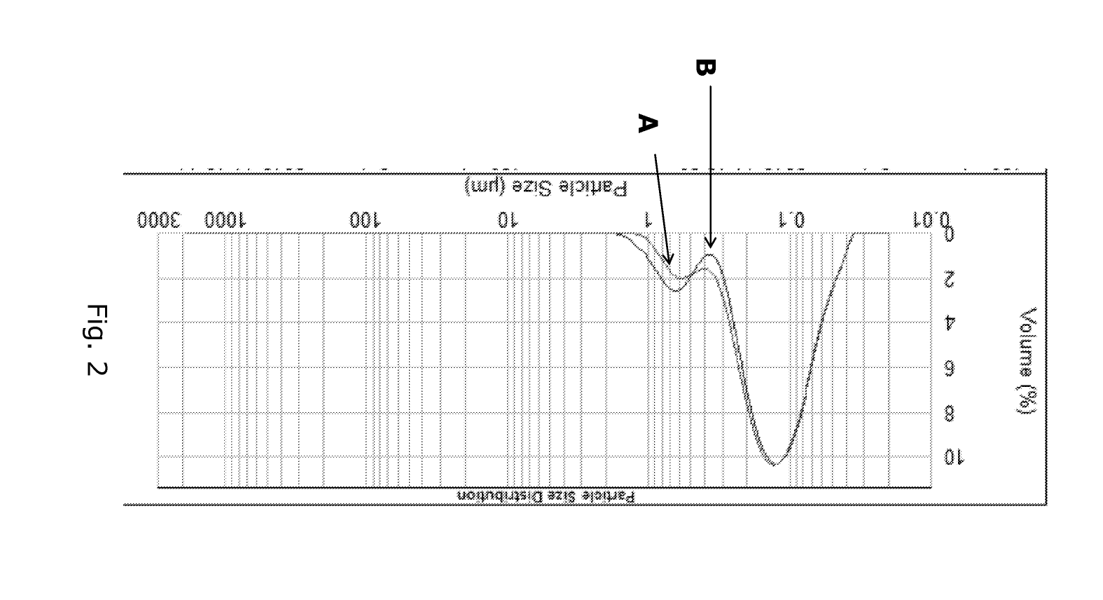

The data presented in example 1 and FIGS. 1-2 clearly shows that the average diameter of a metal silicate composition is reduced by mechanical treatment of metal silicates. The mechanical treatment may be performed by different means. Thus, in an embodiment the mechanical modification treatment is performed by beading, milling, comminuting or grinding, preferably beading using a bead mill.

In another embodiment the mechanical modification treatment is performed by sheer, compression/pressure, acceleration, impact, turbulence ball/bead milling, rotary impact milling and/or micronization.

In the present context the term “first liquid composition comprising metal silicates” relates to any metal silicate composition, whereas the “second composition” relates to a composition comprising metal silicates which has been subjected to a process according to the invention. As described under c) such process may be repeated to further modify the composition.

The period of performing the modification treatment may vary depending on the specific type of treatment and the particle size distribution desired to reach. Thus, in an embodiment said modification treatment, such as mechanical treatment, may be repeated for at least 2 minutes such as at least 5 minutes, such as least minutes, such as at least 20 minutes, such as at least 30 minutes, such as at least 60 minutes, such as at least 60 minutes such as at least 4 hours, or such as at least 8 hours. In yet an embodiment the modification treatment, such as mechanical treatment is repeated for a period of 2 minutes to 8 hours, such as 2 minutes to 4 hours, such as 2 minutes to 60 minutes, such as 15 minutes to 60 minutes, such as 1-3 hours, such 1-2 hour or such as 2-3 hours. The time may be adjusted also by e.g. the force applied during mechanical treatment.

In the case of the use of a bead mill as also illustrated in examples 1-3, the force may also be adjusted by the size of the beads. The optimal size of beads may be determined by determining the size of the particles which are to be exposed to the bead mill.

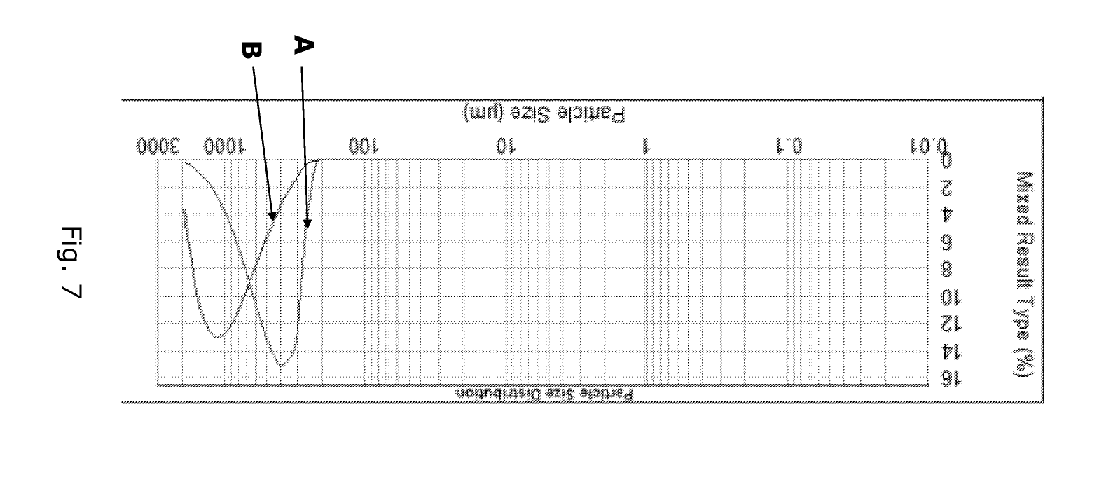

The Particle size distribution in a sodium silicate composition was determined by using a Malvern Mastersizer 2000 instrument with a Hydro S dispersion unit with demineralised water as dispersant. The measurement was performed by means of laser diffraction and particles in the size interval from 0.02-2000 μm are measured. In one batch the unmodified sodium silicate was found to contain two particle sizes One size was represented by a small peak at around 4 μm and the other size was represented by a significant, larger peak at around 100 μm (see examples 1 and 2). In another batch the unmodified sodium silicate only contained one significant peak (see example 3+FIG. 7). Thus, particle distribution may vary from batch to batch.

### Bead Size.

The optimal bead size may be calculated as follows:

Particle size=x; Optimal bead size=x*10; Max grinding result=x/100

In this case x=100 μm
Optimal bead size=1000 μm
Max grinding result=1 μm.

Though the theoretical optimal bead size may be around 1000 μm, other beads sizes may be used to adjust the final particle size. Similar for other types of metal silicates other bead sizes may be preferred depending on the specific particles present in the composition in question. In the example section glass beads with a diameter of 1.55-1.85 mm and zirconia beads with a diameter of 0.4 mm, 0.5 mm, 0.8 mm, 1.3 mm and 2.2 mm have been tested.

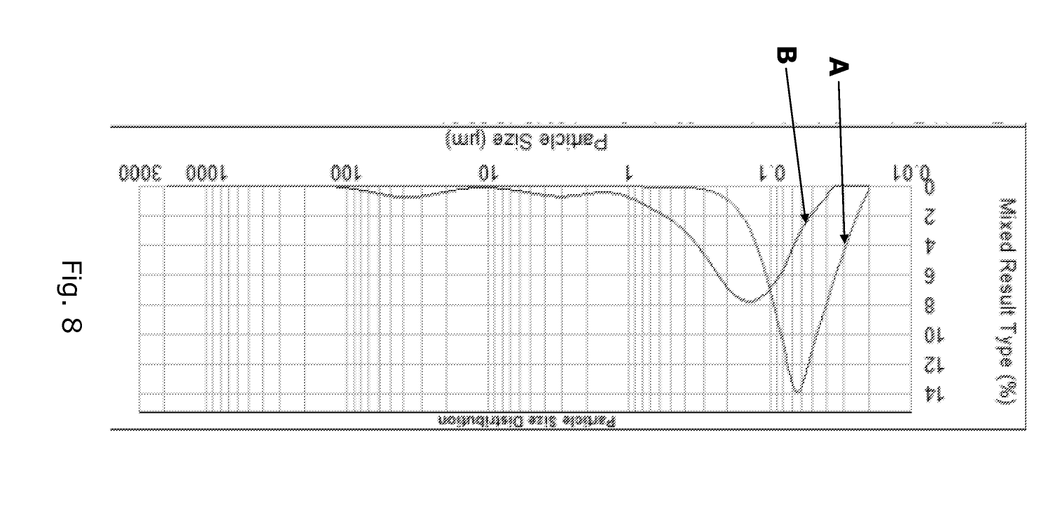

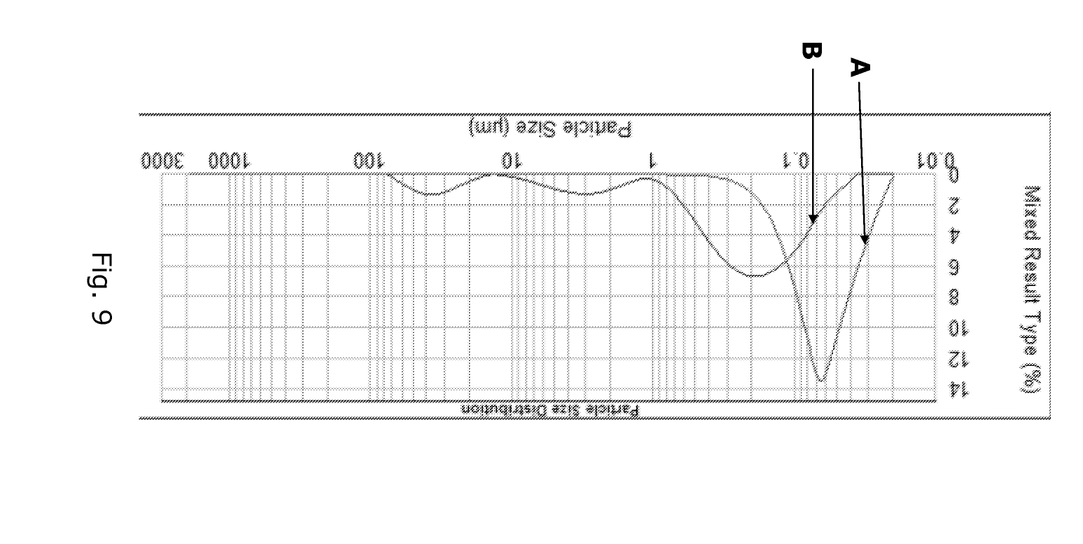

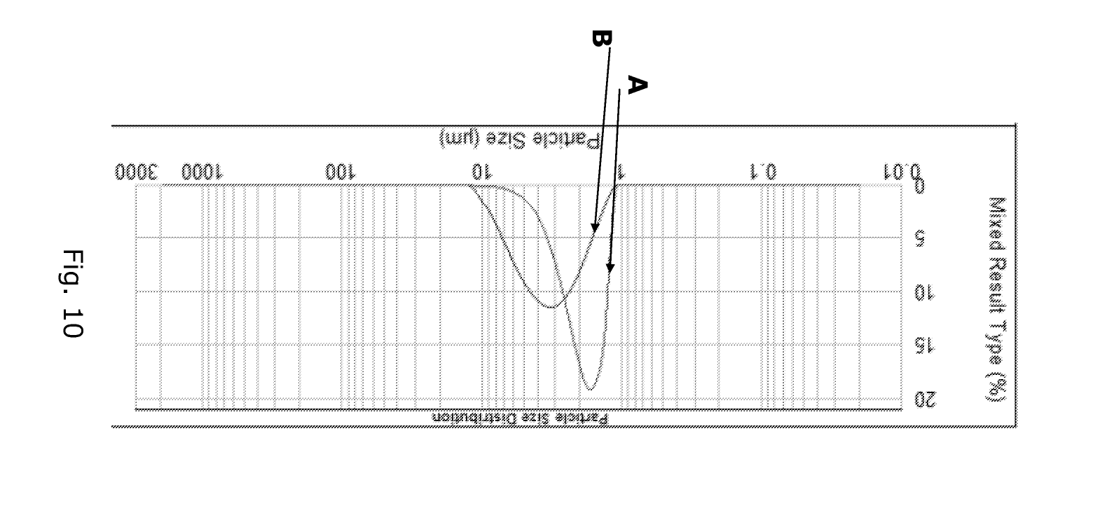

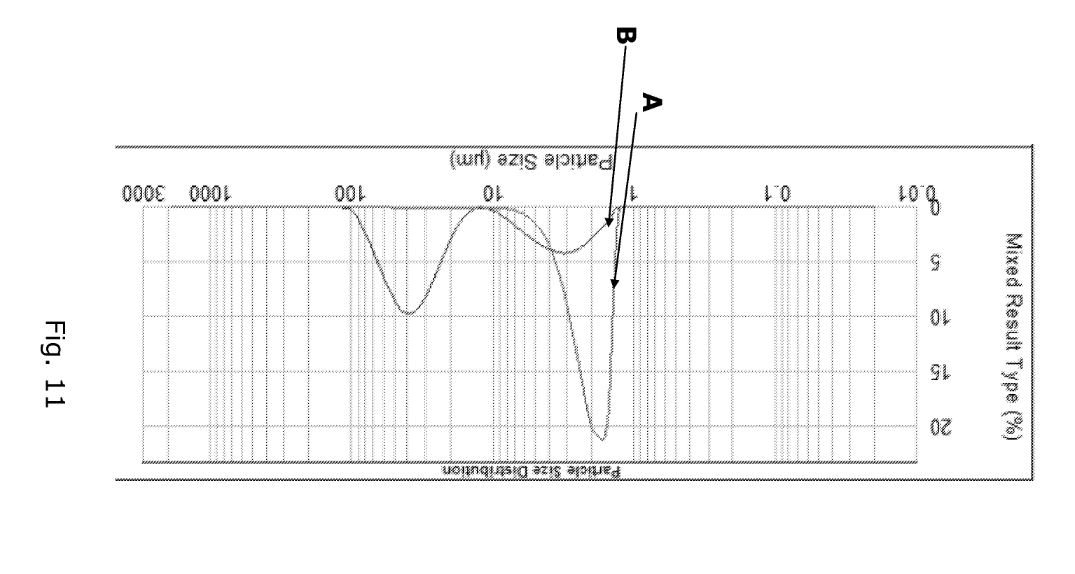

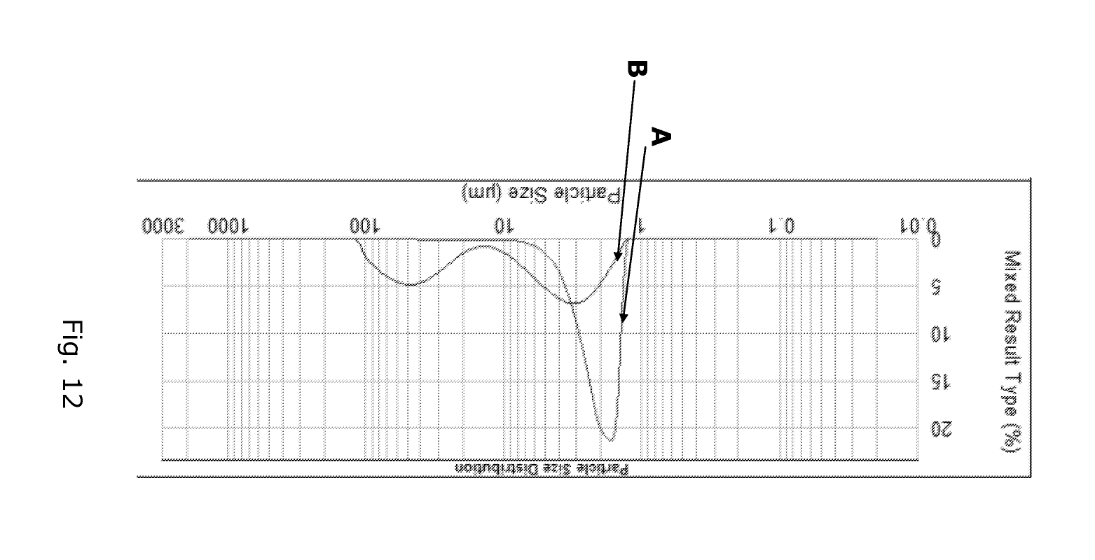

Thus, in an embodiment the beads have an average diameter in the range 20-1300 μm, such as in the range 100-1300 μm, such as in the range 200-1300 μm, such as in the range 300-1300 μm, such as in the range 400-1300 μm, such as in the range 500-1300 μm, such as in the range 20-1000 μm, such as in the range 20-800 μm, such as in the range 20-600 μm, such as in the range 20-400 μm, such as in the range 20-300 μm, such as in the range 20-200 μm, such as in the range 100-700 μm, such as in the range 200-600 μm, such as in the range 300-500 μm. In yet an embodiment the beads have an average diameter in the range 400-2000 μm, such as in the range 800-2000 μm, such as in the range 800-1500 μm, such as in the range 800-1300 μm, such as in the range 800-1200 μm, or such as in the range 1400-2000 μm. Preferably the bead size is in the range 200-1000 μm, more preferably in the range 200-600 μm. In FIGS. 7-12 it can be seen that smaller particle sizes are obtained when beads below 1.3 mm are used in the bead mill. Without being bound by theory, it is believed that the smaller metal silicate particles more easily penetrate into lignocellulotic material such as wood, than the larger particles. This is underlined by example 4, wherein preliminary data show that metal silicate modified to smaller particle sizes have a higher uptake in wood.

A bead may e.g. be made of glass (such as microglass beads) (density of 2.5 g/cc) (g/cc=grams/centimetre cubed), zirconia or titanium. Glass beads are commercially available and may be obtained from Sigmund Lindner. As seen from the example section the obtained particle size distribution depends on the used beads. In a preferred embodiment the beads is made of zirconia (density of 5.5 g/cc) (100% more dense than glass). Other suitable beads may be Zirconia/Silica (density of 3.7 g/cc) (50% more dense than glass), Silicon Carbide (density of 3.2 g/cc), Garnet (an iron-aluminum silicate, sharp particle) (density of 4.1 g/cc), steel (density of 7.9 g/cc), stainless steel, Chrome steel, or Tungsten Carbide (density of 14.9 g/cc). Thus in an embodiment the bead is made of a material selected from the group consisting of zirconia, Zirconia/Silica, Silicon Carbide, Garnet, steel, stainless steel, Chrome steel, and Tungsten Carbide.

In yet an embodiment the bead as a density in the range 2.5-15 g/cc, preferably in the range 3-15 g/cc, and even more preferably in the range 5-15 g/cc. It is believed that beads with a higher density may more efficiently mill the metal silicates compared to e.g. glass beads.

Thus, the skilled person may adjust several parameters e.g. bead type to obtain a desired particle size distribution.

In the present context the particle size distributions are presented based on volume unless otherwise stated.

In a preferred embodiment of the present invention the second metal silicate composition has a reduced particle size distribution of the metal silicates relative to the first metal silicate composition. In yet an embodiment the average diameter of the metal silicates is reduced by at least 50% in the second composition, such as by at least 60%, such as by at least 70%, such as by at least 90%, such as by at least 95%.

In yet an embodiment the average particle diameter of the liquid metal silicates in the second composition (by volume) is less than 100 μm, such as less than 50 μm, such as less than 10 μm, such as less than 5 μm, such as less than 3 μm, such as less than 1 μm, such as less than 0.5 μm, such as less than 0.02 μm, or such as in the range 0.01-35 μm, such as in the range 0.01-10 μm, such as in the range 0.01-5 μm, such as in the range 0.01-2 μm or such as in the range 0.1-100 μm or in the range 0.1-35 μm.

In a preferred embodiment the average particle diameter of the liquid metal silicates in the second composition (by volume) is less than 10 μm, such as less than 5 μm, such as less than 3 μm, such as less than 1 μm, such as less than 0.5 μm, such as in the range 0.01-10 μm, such as in the range 0.01-5 μm, such as in the range 0.01-2 μm, or such as in the range 0.1-2 μm.

Particle size distribution may also be determined by d_{0.1}, d_{0.5} and d_{0.9}, wherein:
d_{0.1}: 10% of the particles (volume) are smaller than this diameter
d_{0.5}: (median) 50% of the particles (volume) are smaller than this diameter
d_{0.9}: 90% of the particles (volume) are smaller than this diameter

Thus, in an embodiment at least 90% (d_{0.9}) of the metal silicate particles in the second composition (by volume) have a particle diameter of less than 100 μm, such as less than 50 μm, such as less than 40 μm, such as less than 35 μm, such as less than 30 μm, such as less than 20 μm, such as less than 10 μm, such as less than 5 μm, such as less than 3 μm, such as less than 1 μm, such as less than 0.5 μm, such as less than 0.02 μm, or such as in the range 0.01-35 μm, such as in the range 0.01-10 μm, such as in the range 0.01-5 μm, such as in the range 0.01-2 μm or such as in the range 0.1-100 μm or in the range 0.1-35 μm.

In a preferred embodiment at least 90% (d_{0.9}) of the metal silicate particles in the second composition (by volume) has an average diameter less than 10 μm, such as less than 5 μm, such as less than 3 μm, such as less than 1 μm, such as less than 0.5 μm, such as in the range 0.01-10 μm, such as in the range 0.01-5 μm, such as in the range 0.01-2 μm, or such as in the range 0.1-2 μm.

In another embodiment at least 50% (d_{0.5}) of the metal silicate particles in the second composition (by volume) have a particle diameter of less than 40 μm, such as less than 30 μm, such as less than 20 μm, such as less than 10 μm, such as less than 5 μm, such as less than 1 μm, such as less than 0.5 μm, such as less than 0.02 μm or such as in the range 0.01-35 μm, such as in the range 0.01-10 μm, such as in the range 0.01-5 μm, such as in the range 0.01-2 μm or such as in the range 0.1-35 μm.

In yet an embodiment at least 10% (d_{0.1}) of the metal silicate particles in the second composition have a particle diameter of less than 3 μm, such as less than μm, such as less than 1 μm, such as less than 0.5 μm, such as less than 0.3 μm, such as less than 0.1 μm, such as less than 0.02 μm, such as in the range 0.01-35 μm, such as in the range 0.01-10 μm, such as in the range 0.01-5 μm, such as in the range 0.01-2 μm or such as in the range 0.1-3 μm.

In a preferred embodiment
at least 90% (d_{0.9}) of the metal silicate particles in the second composition is in the range 0.1 μm-3 μm;
at least 50% (d_{0.5}) of the metal silicate particles in the second composition is less than 1 μm, such as less than 0.5 μm; and
at least 10% the (d_{0.1}) of the metal silicate particles in the second composition is less than 0.5 μm, such as less than 0.3 μm, or such as less than 0.1 μm;

In another preferred embodiment of the invention
at least 90% (d_{0.9}) of the metal silicate particles in the second composition is in the range 0.1 μm-10 μm;
at least 50% (d_{0.5}) of the metal silicate particles in the second composition is less than 6 μm; and
at least 10% (d_{0.1}) of the metal silicate particles in the second composition is less than 3 μm.

In yet another preferred embodiment of the invention
at least 90% (d_{0.9}) of the metal silicate particles in the second composition is in the range 0.01 μm-8 μm;
at least 50% (d_{0.5}) of the metal silicate particles in the second composition is less than 6 μm; and
at least 10% (d_{0.1}) of the metal silicate particles in the second composition is less than 3 μm.

Preferably the beads used for obtaining the above particle distribution have a density in the range 3-15 g/cc.

Different types of metal silicates exist and in the table below some types of metal silicates are listed.

### Type of Metal Silicates

The table shows examples of different types of sodium silicate and potassium silicate and their properties. These metal silicates may be used as starting materials for preparing the metal silicate composition of the present invention, as the first liquid composition comprising metal silicates.

| Type | | | | | |
|---|---|---|---|---|---|
| of metal silicate | °Be | visc. mPa · s | Solid content % | GV % | pH |
| Sodium | 38.3 | 48.3 | 36 | 3.2-3.4 | 12 |
| Type 37/40 | | | | | |
| Sodium | 44.3 | 52.8 | 38.4 | 2 | 14 |
| Type 44 | | | | | |
| Sodium | 46.3 | 72.3 | 40.3 | 2 | 14 |
| Type 46 | | | | | |
| Sodium | 50.3 | 200 | 44.3 | 2 | 14 |
| Type 50 | | | | | |
| Potassium | 40 | 46.6 | 39.4 | 2 | 13 |
| Type 4009 | | | | | |

°Be = Baume,
GV = weight/weight ratio between SiO₂ and Na₂O or between SiO₂ and K₂O.

In an embodiment of the present invention the metal silicate may be selected from the group consisting of sodium silicate, potassium silicate and lithium silicate. Preferably, the metal silicate may be selected from the group consisting of sodium silicate and potassium silicate, more preferably the metal silicate is sodium silicate. Even more preferably the sodium silicate is a type 44 as defined above. In the example section data with type 44 sodium silicate is presented, however decrease in particle sizes have also been obtained with type 36 sodium silicate (data not shown).

Sodium silicate (water glass) is a member of the family of soluble sodium silicates and is considered the simplest form of glass. Water glass is derived by fusing sand and soda ash; it is non-combustible with low toxicity. It may be used as catalysts and silica gels; soaps and detergents; adhesives; water treatment; bleaching and sizing of textiles and paper pulp; ore treatment; soil solidification; glass foam; pigments; drilling muds; binder for foundry cores and molds; waterproofing mortars and cements; and surface impregnating wood.

The liquid metal silicate composition according to the invention may have different pH's depending on the purpose, however preferably the pH is alkaline. Thus, in another embodiment the liquid metal silicate composition has a pH in the range 8.5-14, such as 9-14, such as 11-14 or such as 12-14. At such elevated pHs the composition is stable for long periods of time.

It is known from the prior art that e.g. sodium silicate polymerizes when the pH drops to below 7. However, in protection of cellulosic material this may be an advantage, since polymerization after preservation may limit leaching of the metal silicate from the material. WO 2009/008797 discloses such method where the pH of sodium silicate is rapidly dropped to below 5 to avoid fast polymerization. Thus, in a further embodiment of the present invention the liquid metal silicate composition has a pH in the range 1-5, such as 1-4.5, such as 1-4, such as 2-4, such as 2.5-4, or such as 3.5-4.

### SiO₂ to Na₂O Ratio and SiO₂ to K₂O Ratio

It is known in the art that the particle size distribution of metal silicates also depend on the weight/weight ratio between the metal and the silicate, such as the SiO₂ to Na₂O ratio and SiO₂ to K₂O ratio.

Thus, in an embodiment the weight/weight ratio between the silicate and the metal, such as the SiO₂ to Na₂O ratio, is above 0.50, e.g. above 0.75, such as above 1, e.g. above 1.25, such as above 1.50, e.g. above 1.70, e.g. above 2, such as above 2.25, e.g. above 2.50, such as above 2.75, e.g. above 3, e.g. in the range of 20 to 1, such as 6 to 1, such as 5 to 1, such as 4 to 1 or such as 3.30 to 1.58.

### Metal Silicate Obtainable by a Process

From examples 1 and 2 it can be seen that the overall distribution of the particle sizes changes when the metal silicates are exposed to mechanical modification treatment. Thus an aspect of the invention relates to a liquid composition comprising metal silicate obtainable by a process according to the invention.

Metal Silicates with Reduced Particle Size Distribution

The modified metal silicates obtained by the process of the invention show a different particle size distribution compared to un-modified metal silicates (see examples 1 and 2).

Thus, an aspect of the invention relates to a liquid composition comprising metal silicates, wherein the average particle diameter (measured by volume) of the liquid metal silicates are less than 100 μm, such as less than 50 μm, such as less than 40 μm, such as less than 35 μm, such as less than 30 μm such as less than μm, such as less than 10 μm, such as less than 5 μm, such as less than 3 μm, such as less than 1 μm, such as less than 0.5 μm, such as less than 0.02 μm, such as in the range 0.01-35 μm, such as in the range 0.01-10 μm, such as in the range 0.01-5 μm, such as in the range 0.01-2 μm or such as in the range 0.1-100 μm or in the range 0.1-35 μm.

In a preferred embodiment the average particle diameter (measured by volume) of metal silicates in liquid composition is less than 10 μm, such as less than 5 μm, such as less than 3 μm, such as less than 1 μm, such as less than 0.5 μm, such as in the range 0.01-10 μm, such as in the range 0.01-5 μm, such as in the range 0.01-2 μm, or such as in the range 0.1-2 μm.

In an embodiment at least 90% (d_{0.9}) of the metal silicate particles (measured by volume) have a particle diameter of less than 100 μm, such as less than 50 μm, such as less than 40 μm, such as less than 35 μm, such as less than 30 μm such as less than 20 μm, such as less than 10 μm, such as less than 5 μm, such as less than 3 μm, such as less than 1 μm, such as less than 0.5 μm, such as less than 0.02 μm, such as in the range 0.01-35 μm, such as in the range 0.01-10 μm, such as in the range 0.01-5 μm, such as in the range 0.01-2 μm or such as in the range 0.1-100 μm or in the range 0.1-35 μm.

In a preferred embodiment at least 90% (d_{0.9}) of the metal silicate particles (measured by volume) have a particle diameter of less than 10 μm, such as less than 5 μm, such as less than 3 μm, such as less than 1 μm, such as less than 0.5 μm, such as in the range 0.01-10 μm, such as in the range 0.01-5 μm, such as in the range 0.01-2 μm, or such as in the range 0.1-2 μm.

In yet another aspect the invention relates to a liquid composition comprising metal silicates (measured by volume), wherein at least 50% (d_{0.5}) of the metal silicate particles have a particle diameter of less than 40 μm, such as less than 35 μm, such as less than 30 μm, such as less than 20 μm, such as less than 10 μm, such as less than 5 μm, such as less than 1 μm, such as less than 0.5 μm, such as less than 0.02 μm, or such as in the range 0.01-35 μm, such as in the range 0.01-10 μm, such as in the range 0.01-5 μm, such as in the range 0.01-2 μm or such as in the range 0.1-35 μm.

In a further aspect the invention relates to a liquid composition comprising metal silicates, wherein at least 10% (d_{0.1}) of the metal silicate particles (measured by volume) have a particle diameter of less than 3 μm, such as less than 2 μm, such as less than 1 μm, such as less than 0.5 μm, such as less than 0.3 μm, such as less than 0.1 μm, such as less than 0.02 μm, such as in the range 0.01-35 μm, such as in the range 0.01-10 μm, such as in the range 0.01-5 μm, such as in the range 0.01-2 μm or such as in the range 0.1-3 μm.

In an embodiment at least 90% (d_{0.9}) of the metal silicate particles (measured by volume) have a particle diameter in the range 0.1-100 μm, such as in the range 0.1-50 μm, such as in the range 0.1-40 μm, such as in the range 0.1-35 μm, such as in the range 0.1-30 μm, such as in the range 0.1-20 μm, such as in the range 0.1-10 μm, such as in the range 0.01-35 μm, such as in the range 0.01-10 μm, such as in the range 0.01-5 μm, such as in the range 0.01-2 μm.

In a preferred embodiment of the invention
at least 90% (d_{0.9}) of the metal silicate particles in the composition is in the range 0.1 μm-3 μm;
at least 50% (d_{0.5}) of the metal silicate particles is less than 1 μm, such as less than 0.5 μm; and
at least 10% (d_{0.1}) of the metal silicate particles is less than 0.5 μm, such as less than 0.3 μm, or such as less than 0.1 μm.

In another preferred embodiment of the invention
at least 90% (d_{0.9}) of the metal silicate particles in the composition is in the range 0.1 μm-10 μm;
at least 50% (d_{0.5}) of the metal silicate particles is less than 6 μm; and
at least 10% (d_{0.1}) of the metal silicate particles is less than 3 μm.

In yet another preferred embodiment of the invention
at least 90% (d_{0.9}) of the metal silicate particles in the second composition is in the range 0.01 μm-8 μm;
at least 50% (d_{0.5}) of the metal silicate particles in the second composition is less than 6 μm; and
at least 10% (d_{0.1}) of the metal silicate particles in the second composition is less than 3 μm.

The solid content of the metal silicates in the composition may vary. Thus, in an embodiment the solid content of the metal silicates in the composition is at least 20% by weight, such as at least 25%, such as at least 30% or such as at least 35%.

Particle size distribution may be determined by different means. In an embodiment the particle size is determined using a Malvern Mastersizer 2000 instrument with a Hydro S dispersion unit with demineralized water as dispersant. This is the assay used in the example section.

### Preserving Cellulosic Material

A composition according to the invention may find use in many applications. However one particular application may be in preservation of cellulosic material. Thus, in an embodiment said composition is an agent for preserving cellulosic material, such as wood. As previously mentioned penetration into wood structures of metal silicates, has previously been recognized as a challenge for metal silicates. Without being bound by theory, it is believed that the reduced particle size of the modified metal silicates may enable more easy penetration into wood structures.

Thus an aspect of the invention relates to the use of a composition according to the invention for preserving cellulosic material.

In the present context the terms “preservation”, “preserved” or “preservation agent” relates to an improvement of cellulosic material compared to a control material without metal silicate. An enhancement may be in relation to fire protection, attacks from insects such as termites, and attacks from micro-organisms, such as fungus and bacteria. Thus, in an embodiment the cellulosic material according to the invention is preserved with metal silicate. In a corresponding embodiment the process according to the invention relates to a process for providing a cellulosic material preserved with a metal silicate.

A further benefit of providing enhancement according to the present invention is the benefit on the environmental safety due to non-toxicity of the composition relative to other known fungicides and fire retardant components.

The composition according to the invention is capable of maintaining a reduced particle size over a long period of time, preferably, without having to take special precautions. Thus, in an embodiment said particle size distribution is stable for at least 2 hours, at least 10 hours, at least 1 day, at least 2 days, at least 5 days, at least 20 days, at least 40 days, such as at least 60 days, or such as at least 90 days. As described in the examples, a reduced particle is maintained for at least days.

Since the compositions according to the invention may be used as an agent for impregnating wood it may be advantageous to add a surface tension reducing agent (wetting agent) to the compositions. It is believed that such agent may improve the uptake of the metal silicate in e.g. wood. Thus, in an embodiment of the invention, the composition further comprises one or more surface tension reducing agent (wetting agent). In an embodiment the one or more surface tension reducing agents are selected from the group consisting of alcohol ethoxylate with chain length C9-C11, alcohol ethoxylate C10-C16, quaternary coco alkyl methyl amine ethoxylate methyl chloride, disodium cocoamphodipropionate and mixtures thereof. The skilled person may find other agents or mixtures of agents which will have similar effects. In an embodiment the wetting agent is present in the composition in an amount of less than 10% by weight, such as less than 5%, less than 3%, such as in the range 0.01-10%, such as in the range 0.1-10%, such as 0.01-5%, such as in the range 0.1-5%, such as in the range 0.1-2%, such as in the range 0.1-1%, such as in the range 0.1-0.5%, such as in the range 0.01-0.5%.

In yet an aspect the invention relates to a process for providing a cellulosic material comprising metal silicate, said method comprising the steps of:
providing a liquid composition comprising metal silicate according to the invention,
optionally diluting or concentrating said liquid composition comprising metal silicate, and
positioning said liquid composition comprising metal silicate into and/or onto said cellulosic material, providing a cellulosic material comprising metal silicate.

In an embodiment a wetting agent is added to the composition before the composition is applied to the cellulosic material (e.g. wood).

Yet an aspect relates to a cellulosic material obtainable by a process according to the invention.

As described above, it is well known in the art that e.g. sodium silicate may improve preservation of cellulosic materials, such as wood. However, it is also known that sodium silicate cannot penetrate very well into wood unless very dilute compositions are used. Thus, sodium silicate preservation may only result in surface preservation, which of course is less efficient, e.g. if preserved wood is subsequently cleaved into smaller units or wear which would result in surfaces starts appearing which are not preserved. Thus, in yet an aspect the invention relates to the use of a composition according to the invention for preserving cellulosic material.

It is to be understood that the composition according to the present invention may be part of e.g. a liquid paint formulation.

In the present context the term “cellulosic material” refers to materials comprising cellulose, such as plywood, fibreboard and wood. In a preferred embodiment the cellulosic material according to the invention is wood.

In the present context the term “wood” refers to fibrous tissue found in many plants. It is an organic material, a natural composite of cellulose fibers (which are strong in tension) embedded in a matrix of lignin which resists compression. It is common to classify wood as either softwood or hardwood. The wood from conifers (e.g. pine) is called softwood, and the wood from dicotyledons (usually broad-leaved trees, e.g. oak) is called hardwood.

Wood may be further divided into heartwood and sapwood. Heartwood is wood that as a result of a naturally occurring chemical transformation has become more resistant to decay. Heartwood may (or may not) be much darker than living wood. It may (or may not) be sharply distinct from the sapwood. However, other processes, such as decay, can discolour wood, even in woody plants that do not form heartwood, with a similar colour difference, which may lead to confusion. Sapwood is the younger, outermost wood; in the growing tree it is living wood, and its principal functions are to transport water from the roots to the leaves and to store up and give back according to the season the reserves prepared in the leaves. However, by the time it become incompetent to conduct water, all xylem tracheids and vessels have lost their cytoplasm and the cells are therefore functionally dead. All wood in a tree is first formed as sapwood.

In an embodiment said wood is hardwood or softwood or a combination thereof. In another embodiment said wood comprises heartwood and/or sapwood. In a preferred embodiment said wood is sapwood, e.g. from pine.

Further examples of wood materials according to the present invention are timber and lumber (boards) of different sizes and shapes.

A fire retardant material is one having properties that provide comparatively low flammability or flame spread properties. There are a number of materials that have been used to treat wood for fire retardancy including ammonium phosphate, ammonium sulfate, zinc chloride, dicyandiamide-phosphoric acid and sodium borate.

In the present context the term “into said cellulosic material” refers to the situation where the metal silicate according to the present invention is detectable inside the wood structure. In an embodiment of the present invention the metal silicate according to the present invention is detectable more than 1 mm into said cellulosic material, such as more than 2 mm, such as more than 3 mm, such as more than 4 mm, or such as more than 5 mm.

In the present context the term “onto said cellulosic material” refers to the situation where the metal silicate according to the present invention is only detectable on the surface of the cellulosic material. In an embodiment of the present invention the metal silicate according to the present invention is only detectable for at most 1 mm into said cellulosic material, such as at most 0.5 mm into said cellulosic material, e.g. at most 0.25 mm into said cellulosic material. It is to be understood by the mentioned distance, that it relates to the distance from any surface of said cellulosic material, wherein said surface is a surface visible to the human eye. Thus, a “surface” is not a microscopic surface present inside e.g. a wood structure, but relates to what would normally be considered the surface of e.g. a standard wood board. Thus, in an embodiment said surface is a visible surface.

Without being bound by theory it is believed that the modified liquid metal silicate composition (second composition of the process) of the present invention is able to penetrate the cellulosic material (the sapwood) and enter into the cellulosic material, whereas the unmodified liquid metal silicate composition (the first composition of the process) will not be able to enter into the cellulosic material to the same degree but stays on the surface of the cellulosic material.

Due to the reduced particle size the solid content of metal silicates may be raised. Thus, in an embodiment the liquid composition comprising metal silicates according to the invention has a solid content of the metal silicate in the range 0.5%-80%, such as in the range 0.5%-70%, such as in the rang, 0.5%-60%, such as in the range, 0.5%-50%, such as in the range, 0.5%-40%, such as in the range, 0.5%-30%, such as in the range, 0.5%-20%, such as in the range 0.5%-10%, such as in the range 0.5%-5%, such as in the range 0.5%-3%. Since this may also depend on the specific type of cellulosic material the user has to consider whether it is appropriate to dilute or concentrate the composition before use.

Without being bound by theory, since heart wood is denser in structure than sapwood it is more difficult to get the liquid metal silicate composition into heartwood compared to sapwood. On the other hand sapwood has a more open structure which may allow the metal silicate composition to penetrate more deeply into the structure. Some cellulosic material, such as boards may comprise both heartwood and sapwood and they may not be equally modified with the liquid metal silicate composition. However since heartwood is much more resistant to e.g. moisture and therefore also microorganisms such difference may not affect the overall preservation of the material.

The cellulosic material may preferably have a volume of at least about 0.5 cm³, such as at least 1 cm³, such as at least 2 cm³, such as at least 5 cm³, such as at least 50 cm³, such as at least 500 cm³, such as at least 1000 cm³, such as at least 10000 cm³. It is to be understood that timber or boards may have a much larger volume.

In an embodiment the material is not biologically pre-treated, such as with blue-stain fungus. Such procedure is e.g. described in WO2009/087262. Biological pre-treatment may weaken the cellulosic material, e.g. the wood structure and may therefore be undesirable in order to provide a cellulosic material of high quality. Furthermore, such pre-treatment is a slow, inhomogeneous, and un-reproducible process which would result in an increased price.

The metal silicate composition may be positioned into or onto the cellulosic material by different means. Thus, in an embodiment said positioning is performed by at least one of the methods selected from the group consisting of reduced pressure, e.g. vacuum, added pressure, dipping, brushing, spraying, and sap-, microwaving, high-frequency, and introduction of the sodium silicate composition in a supercritical state. Such processes are known to the person skilled in the art and will not be discussed in further detail.

Though it is known that liquid metal silicates cannot penetrate deeply into the cellulosic material, e.g. wood structures several attempts have been performed. One of the typical obstacles which has turned op is that the metal silicate will leach from the cellulosic material, e.g. wood, since it is located on the surface of the cellulosic material and because it is water soluble. Several different solution to the problem has been found all of which include hardening the metal silicate composition after it has been applied onto e.g. a wood board. Thus, in an embodiment the process further comprises hardening said liquid metal silicate composition after the liquid metal silicate composition has been positioned into and/or onto said cellulosic material.

In yet an embodiment said hardening is provided by
exposing said liquid metal silicate preserved material to energy, such as heat or radiation, and/or
adding a coagulant, and/or
adding a hardener to said material such as an acid, CO₂, bicarbonate, or one or more metal salt such as calcium chloride and/or zink chloride,

The principle behind these types of hardening is that the metal silicate will polymerize thus become water insoluble and subsequently be unable to leach from the material or perform a reduced leaching. The problem with leaching may be less pronounced if the liquid metal silicate is positioned inside a cellulosic material such as a wood structure, opposed to standard positioning of the metal silicate where it will only be positioned on the surface of the cellulosic material, e.g. wood structure due to lack of penetration. In the present context the term “leaching” refers to the loss of a part of the metal silicate composition from the cellulosic material over a period of time. Leaching may be due to rain or high moisture content in the surrounding environment. In the present context the term “hardening” refers to the situation where the metal silicate composition or part of the metal silicate composition is stabilized. Hardening may be by polymerization of the metal silicate which reduces the water solubility and makes it difficult for the metal silicate to leach from the cellulosic material.

Another possible process to avoid or reduce leaching may be to combine heating and reduced pressure, e.g. vacuum. Thus, in another embodiment said hardening process is performed under reduced pressure, e.g. vacuum, at a temperature in the range 45-85° C. Thus, in a further embodiment, said temperature is in the range 55-85° C., such as 65-85° C., or such as 75-85° C. In a further embodiment said temperature is in the range 45-75° C., such as 45-65° C., or such as 45-55° C. The advantage of the reduced pressure, e.g. vacuum, is that the effect of heating at standard pressure may be obtained at a lower temperature. This is an advantage for cellulosic material, e.g. wood, where too high a temperature may affect the strength of the cellulosic material, e.g. wood, and may result in bending of the cellulosic material, e.g. wood boards. In a further embodiment said reduced pressure or vacuum is in the range 0.1-0.9 bar, such as 0.20-0.90 bar, such as 0.30-0.90 bar, such as 0.40-0.90 bar, such as 0.50-0.90 bar, such as 0.60-0.90 bar, such as 0.70-0.90 bar, or such as 0.80-0.90 bar. In yet an embodiment said reduced pressure or vacuum is in the range 0.1-0.8 bar, such as 0.10-0.70 bar, such as 0.10-0.60 bar, such as 0.10-0.50 bar, such as 0.10-0.40 bar, such as 0.10-0.30 bar, or such as 0.10-0.20 bar. In another embodiment said hardening process takes place for 10 minutes to 24 hours, such as 1-24 hours, such as 3-24 hours, such as 5-24 hours, such as 8-24 hours, such as 12-24 hours, such as 16-hours, or such as 20-24 hours. In another embodiment said hardening process takes place for 10 minutes to 20 hours, such as 1-16 hours, such as 1-12 hours, such as 1-8 hours, or such as 1-4.

In an embodiment said reduced pressure, e.g. vacuum, is in the range 1-90% vacuum and said temperature is in the range 45-85° C. In a further embodiment said hardening process is performed for 30 minutes to 24 hours, such as 0-24 hours.

When the composition according to the invention is used for wood preservation it may be advantageously to have other components added to the composition.

Thus, in yet an embodiment the liquid metal silicate composition further comprises one or more colouring agents. In yet a further embodiment the liquid metal silicate composition further comprises one or more stability enhancing agents. Coloring agent may be beneficial if there is a need to change the appearance of the cellulosic material e.g. wood boards.

### Cellulosic Material Obtainable by a Process According to the Invention

In a preferred embodiment the invention relates to a cellulosic material obtainable by a process according to the invention.

In another aspect the invention relates to a cellulosic material comprising metal silicate
comprising detectable metal silicate more than 1 mm from any surface of said material, such as more than 2 mm, such as more than 3 mm, such as more than 4 mm, such as more than 5 mm, such as more than 6 mm, such as more than 8 mm, such as more than 10 mm, such as more than 20 mm such as more than 30 mm, and/or
wherein at least 10%, such as at least 20%, such as at least 30%, such as at least 40%, such as at least 50%, such as at least 60% such as at least 70%, such as at least 80%, such as at least 90% or such as at least 95% of said cellulosic material is preserved with metal silicate, and/or
having a weight/weight ratio between the cellulosic material and metal silicate of at most 100:1, such as 10:1, such as at most 8:1, such as at most 5:1, such as at most 3:1, or such at most 1:1.
comprising at least 50 kg metal silicate/m3 of cellulosic material, such as at least 100 kg metal silicate/m3, such as at least 150 kg metal silicate/m3, such as at least 200 kg metal silicate/m3, such as at least 250 kg metal silicate/m3, such as at least 300 kg metal silicate/m3, such as at least 350 kg metal silicate/m3, such as at least 400 kg metal silicate/m3, such as at least 500 kg metal silicate/m3, such as at least 600 kg metal silicate/m3, such as at least 700 kg metal silicate/m3, such as at least 800 kg metal silicate/m3, such as at least 900 kg metal silicate/m3, such as in the range 50 kg to 2000 kg metal silicate/m3, such as, in the range 50 kg to 1800 kg metal silicate/m3, such as in the range 50 kg to 1500 kg metal silicate/m3, such as in the range 50 kg to 1300 kg metal silicate/m3, or such as in the range 50 kg to 1000 kg metal silicate/m3.

The presented aspect solves the problem of pre-treatment of the cellulosic material as previously described. The above features describing the presence of the metal silicate in the cellulosic material all relates to the presence of metal silicate throughout a large proportion of the cellulosic material. The amount of metal silicate present inside the cellulosic material may be determined by different methods:
Measurements of the distribution of metal silicate in the cellulosic material may be determined by electron microscopy.
The percentage of preserved cellulosic material may be determined as the amount of material wherein metal silicate can be determined.
The weight/weight ratio may be determined by measuring the dry weight of the cellulosic material before and after the preservation treatment, or by comparison to a reference level.

Cellulosic materials as described above, may be obtained by a process according to the present invention. In a more specific embodiment said cellulosic material has not been pre-treated with blue-stain fungus. In yet a specific embodiment said cellulosic material does not comprise viable or non-viable blue-stain fungus or tracers thereof. It may be determined by the eye if a cellulosic material has been pre-treated/infected with the blue stain fungus, since there is a visible change in the colour. However, molecular analysis may also be performed. It is noted that without pre-treatment of the cellulosic material the metal silicate may not enter into the wood structures.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Particle Size Distribution

### Test Setup

Source of metal silicate: Sodium silicate type 44
Bead mill: WAB DYNO®-MILL MULTI LAB 0.6 l,
Bead type and size: zirconia, diameter 0.5 mm
Process time: 120 minutes

Particle size distribution was determined using a Malvern Mastersizer 2000 instrument with a Hydro S dispersion unit with demineralized water as dispersant. The measurement was performed by means of laser diffraction and particles in the size interval from 0.02-2000 μm are measured. The particle size distribution is calculated based on the assumption that the particles are spherical. Each sample is measured with stirring to avoid potential sedimentation of particles.

### Methods

The sodium silicate type 44 was modified in the bead mill using for a period of 120 minutes using recirculation.

Both un-modified and modified sodium silicate was in one experiment exposed to sonication, to test the effect of sonication.

Subsequently the particle size distribution was measured using a Malvern Mastersizer 2000 instrument with a Hydro S dispersion unit with demineralized water as dispersant (see example 1).

In one test the particle distribution measurements were performed 22 days after the modification treatment, indicating that the modified metal silicates maintains are smaller particle size for at least this period.

### Results

The “un-modified” sample contained two particle size distributions. The two distributions were more distinct after sonication (FIG. 1). The 120 min modified sample also showed signs of two distributions, of which the fine particle size (<0.50 micron) was dominating. Sonication did not have any significant effect.

Comparing the two samples, the un-modified sample was much coarser than the min modified sample.

d_{0.1}: 10% of the particles (volume) are smaller than this diameter
d_{0.5}: (median) 50% of the particles (volume) are smaller than this diameter
d_{0.9}: 90% of the particles (volume) are smaller than this diameter

| Sample | | | | |
|---|---|---|---|---|
| No | Type | d_{0.1} | d_{0.5} | d_{0.9} |
| 1 | Unmodified without sonication | 3.71 μm | 46.5 μm | 145 μm |
| | (B) | | | |
| 2 | Unmodified after sonication (A) | 3.63 μm | 72.4 μm | 150 μm |
| 3 | 120 min mechanical treatment - | 0.07 μm | 0.14 μm | 0.55 μm |
| | before sonication (B) | | | |
| 4 | 120 min mechanical treatment - | 0.07 μm | 0.14 μm | 0.37 μm |
| | after sonication (A) | | | |

Sample 1 and 2: A) shows the distribution after 1 minute of sonication; B) shows the particle size distribution before sonication (FIG. 1). A sharper distinction between the two particle distributions is seen after sonication. The particle size range of the distributions is unaltered.

Sample 3 and 4: No significant effect of sonication is observed (FIG. 2).

### Conclusion

Metal silicates with a reduced particle size distribution can be obtained by mechanical modification treatment such as by the use of a bead mill. The reduction in particle size appears stable for several weeks, since there was inserted a gap in time of 22 days between the modification treatment and the particle size distribution measurements.

### Example 2

### Particle Size Distribution

### Test Setup

Source of metal silicate: Sodium silicate type 44
Bead mill: WAB DYNO®-MILL KD15,
Bead type and size: Glass beads; 1.55-1.85 mm
Process time: See setup

Particle size distribution was determined using a Malvern Mastersizer 2000 instrument with a Hydro S dispersion unit with demineralized water as dispersant. The measurement was performed by means of laser diffraction and particles in the size interval from 0.02-2000 μm are measured. The particle size distribution is calculated based on the assumption that the particles are spherical. Each sample is measured with stirring to avoid potential sedimentation of particles.

### Methods

The sodium silicate type 44 was modified in the bead mill using the following setup:
Unmodified;
1 Run-through in the bead mill;
3 Run-throughs in the bead mill;
Re-circularized for two hours.

Subsequently the particle size distribution was measured using a Malvern Mastersizer 2000 instrument with a Hydro S dispersion unit with demineralized water as dispersant (see also example 1).

### Results

d_{0.1}: 10% of the particles (volume) are smaller than this diameter
d_{0.5}: (median) 50% of the particles (volume) are smaller than this diameter
d_{0.9}: 90% of the particles (volume) are smaller than this diameter

| Sample No | Type | d_{0.1} | d_{0.5} | d_{0.9} |
|---|---|---|---|---|
| 5 | Unmodified | 10.2 μm | 135 μm | 198 μm |
| 6 | 1 Run-through in the bead | 2.23 μm | 4.87 μm | 51.7 μm |
| | mill | | | |
| 7 | 3 Run-through in the bead | 2.1 μm | 3.59 μm | 7.1 μm |
| | mill | | | |
| 8 | Re-circularized for two hours | 2.04 μm | 4.45 μm | 72.2 μm |

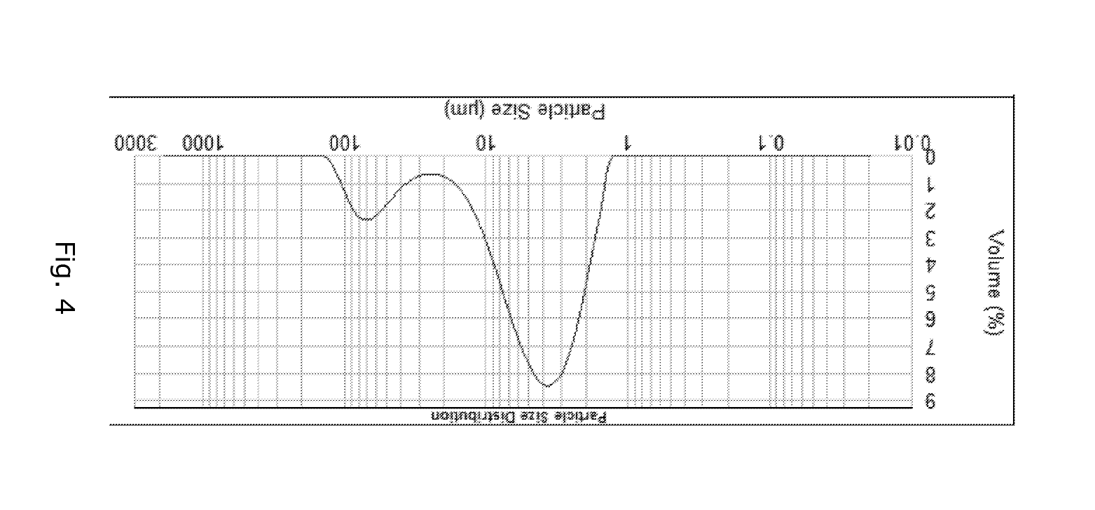

The data show, in accordance with example 1, that the three different modification tests (sample 6-8) all resulted in a decrease in the particle size distribution, although the degree of modification was less pronounced in this example. Some of the difference observed between the size distribution in the un-modified sodium silicates used in example 1 and 2 may be due to the fact that different batches of sodium silicate were used. However, by comparing FIGS. 1 and 4 it can be seen that the overall distribution is highly similar.

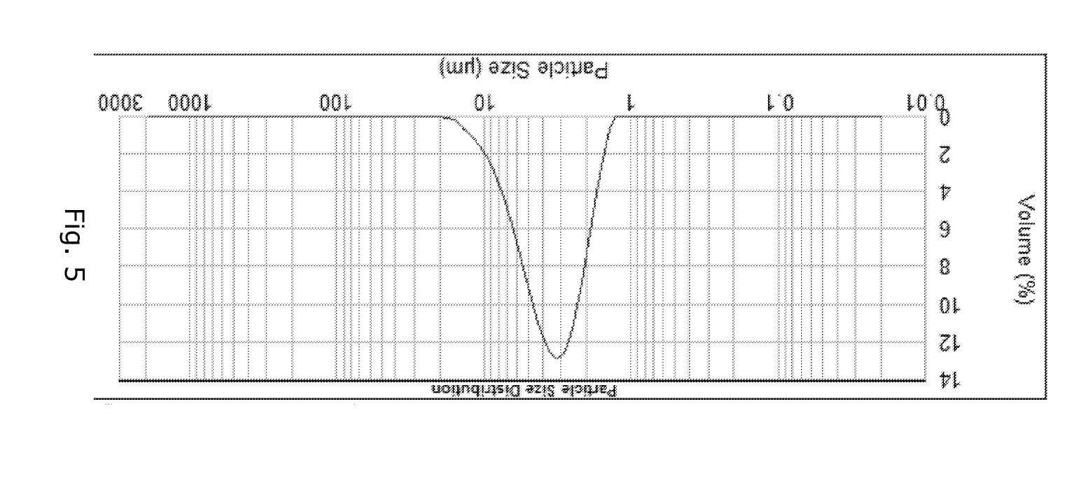

By comparing the tests using 1 and 3 run-throughs it can be seen that by repeating the modification treatment 3 times that a larger fraction the particles become reduced in sized (compare FIGS. 4 and 5).

### Conclusion

The data presented in this example verifies the data from example 1; that a reduction in particle size distribution can be obtained by using mechanical treatment. The difference in the obtained particle sizes is likely due to the different bead mill and different types of beads (size and material) used in the two examples.

### Example 3

Six Type 44 sodium silicate samples were tested for particle size distribution measurements.
Type 44 unmodified
Type 44 bead size 0.4 mm, zirconia beads, t=20 min
Type 44 bead size 0.8 mm, zirconia beads, t=20 min
Type 44 bead size 1.3 mm, zirconia beads, t=20 min
Type 44 bead size 1.55-1.85 mm, glass beads, t=20 min
Type 44 bead size. 2.2 mm zirconia beads, t=20 min

Particle size distribution was determined using a Malvern Mastersizer 2000 instrument with a Hydro S dispersion unit with demineralized water as dispersant. The measurement was performed by means of laser diffraction and particles in the size interval from 0.02-2000 μm are measured. The particle size distribution is calculated based on the assumption that the particles are spherical. Each sample is measured with stirring to avoid potential sedimentation of particles.

### Results

The particle size distribution was measured both based on volume and particle numbers.

d_{0.1}: 10% of the particles (volume or number) are smaller than this diameter
d_{0.5}: (median) 50% of the particles (volume or number) are smaller than this diameter
d_{0.9}: 90% of the particles (volume or number) are smaller than this diameter

| Sample | d_{0.1} | d_{0.5} | d_{0.9} |
|---|---|---|---|
| Volume based | | | |
| unmodified | 495 μm | 967 μm | 1593 μm |
| Bead size 0.4 mm, | 0.08 μm | 0.18 μm | 2.07 μm |
| zirconia | | | |
| Bead size 0.8 mm, | 0.09 μm | 0.24 μm | 5.41 μm |
| zirconia | | | |
| Bead size 1.3 mm, | 1.88 μm | 3.46 μm | 6.69 μm |
| zirconia | | | |
| Bead size | 2.66 μm | 29.9 μm | 60.2 μm |
| 1.55-1.85 mm, glass | | | |
| Bead size 2.2 mm | 2.26 μm | 6.46 μm | 65.5 μm |
| zirconia, t = 20 m | | | |
| Number based | | | |
| unmodified | 311 μm | 473 μm | 897 μm |
| Bead size 0.4 mm, | 0.03 μm | 0.06 μm | 0.12 μm |
| zirconia | | | |
| Bead size 0.8 mm, | 0.04 μm | 0.07 μm | 0.13 μm |
| zirconia | | | |
| Bead size 1.3 mm, | 1.39 μm | 1.94 μm | 3.30 μm |
| zirconia | | | |
| Bead size | 1.57 μm | 2.11 μm | 3.46 μm |
| 1.55-1.85 mm, glass | | | |
| Bead size 2.2 mm | 1.57 μm | 2.10 μm | 3.47 μm |
| zirconia | | | |

The graphs of the particle distributions are shown in FIGS. 7-12.

Overall it can be seen that by using beads in the range 0.4-0.8 mm the smallest particles are obtained. When using larger beads the effect is less pronounced though still particles significant smaller than for unmodified sodium silicate is obtained.

Examples 1-3 show that by controlling the bead size, bead type, and time, the particle size distribution can be controlled.

### Example 4

### Uptake of Modified Metal Silicate in Wood Boards

### Methods

Wood boards were impregnated with modified and unmodified sodium silicate type 44 using standard vacuum impregnation. The uptake of metal silicate was subsequently determined based on increase in weight after drying.

### Results

The preliminary data indicates that modified type 44 sodium silicate more easily enters into the interior of the wood boards than do unmodified type 44 sodium silicate.

### Conclusion

By modifying metal silicate to a smaller particle sizes metal silicate can more easily enter into wood structures and thus improve impregnation.

1. A method of preserving a cellulosic material comprising:
contacting a cellulosic material with a liquid composition comprising sodium silicates, wherein the average particle diameter of the sodium silicates is less than 100 μm, and
wherein at least 90% (d_{0.9}) of the sodium silicates have a particle diameter of less than 5 μm.

2-11. (canceled)

12. The method according to claim 1, wherein at least 90% (d_{0.9}) of the sodium silicate particles have a particle diameter in the range of 0.1-5 μm.

13. The method according to claim 1, wherein at least 90% (d_{0.9}) of the sodium silicate particles have a particle diameter of less than 3 μm.

14. The method according to claim 1, wherein the liquid composition further comprises one or more wetting agents.

15. The method according to claim 1, wherein the preservation provides protection from fire.

16. The method according to claim 1, wherein the preservation provides protection from insects.

17. The method according to claim 1, wherein the preservation provides protection from micro-organisms.

18. A method of making a preservative for cellulosic material, comprising:
a) providing a first liquid composition that comprises sodium silicates,
b) subjecting said first liquid composition to a mechanical treatment, which produces a second liquid composition, wherein the average particle size of the sodium silicates in the second liquid composition is reduced relative to the average particle size of the sodium silicates in the first liquid composition, and
c) optionally, subjecting said second liquid composition to one or more steps of said mechanical treatment, wherein the mechanical treatment is performed by a bead mill, wherein the beads in the bead mill are zirconia beads.

19. The method according to claim 18, wherein the average particle diameter of the sodium silicates is less than 100 μm and, wherein at least 90% (d_{0.9}) of the sodium silicate particles have a particle diameter of less than 5 μm.

20. The method according to claim 18, wherein at least 90% (d_{0.9}) of the sodium silicate particles have a particle diameter in the range of 0.1-5 μm.
